(19) United States
(12) Patent Application Publication
(10) Pub. No.: US 2023/0219820 A1
(43) Pub. Date: Jul. 13, 2023

(54) CRACKING PROCESS FOR REACTIVE DISTILLATION OF CHLOROSILANE SLURRY

(71) Applicant: Institute of Process Engineering, Chinese Academy of Sciences, Beijing (CN)

(72) Inventors: Chao HUA, Beijing (CN); Hongxing WANG, Beijing (CN); Fang BAI, Beijing (CN); Ping LU, Beijing (CN); Hai LI, Beijing (CN)

(73) Assignee: Institute of Process Engineering, Chinese Academy of Sciences, Beijing (CN)

(21) Appl. No.: 18/095,006

(22) Filed: Jan. 10, 2023

(30) Foreign Application Priority Data
Jan. 11, 2022 (CN) 202210025140.9

(51) Int. Cl. C01B 33/107; B01D 3/00; B01D 3/14

(52) U.S. Cl. CPC C01B 33/1071; B01D 3/009; B01D 3/143

(57) ABSTRACT

A cracking process for a reaction distillation of chlorosilane slurry includes feeding a chlorosilane slurry into a phase separator, drying a solid phase, feeding a chlorosilane polymer into a plate distillation column, returning kettle materials of the plate distillation column, and dividing a material produced from a top of the column. The process adopts an ionic liquid catalyst, which is environmentally friendly and reusable. The cracking and distillation of chlorosilane polymer are carried out simultaneously to shorten the time and increase the utilization rate of raw materials, which can reduce energy consumption and save costs and facilitate industrial production. A plate column is used as a distillation column, in which the two phases of the gas and liquid are sufficiently contacted. Therefore, the transfer of mass and heat is good, the production capacity is good, and the tower is not easily blocked, thereby making it easy to clean.

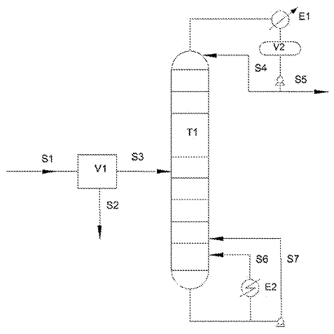

### CROSS REFERENCE TO THE RELATED APPLICATIONS

This application is based upon and claims priority to Chinese Patent Application No. 202210025140.9 filed on Jan. 11, 2022, the entire contents of which are incorporated herein by reference.

### TECHNICAL FIELD

The present invention belongs to the technical field of chemical engineering, particularly a cracking process for a reactive distillation of chlorosilane slurry.

### BACKGROUND

In the new energy photovoltaic industry, there are difficulties with the complex composition, high toxicity, and low resource conversion rate as well as high energy consumption in the processing of the highly concentrated chlorosilane solid-liquid slurry produced by polysilicon devices. The main components of the highly concentrated chlorosilane slurry include chlorosilane polymers that generally contain chlorosilane, polysilane, siloxane, a small amount of solid matter and insoluble metal impurities, and ultrafine silicon powders generated during the synthesis process. The components have a strong adverse effects on the eyes and upper respiratory tract. If they are in contact with the human body, the high concentrations of the components not only cause corneal opacity, severe burns of the cornea and eyelid, respiratory tract inflammation, and skin tissue necrosis but also cause hemolytic reactions leading to anemia. If the components are directly discharged into the environment, they will cause great harm to the natural environment, such as the soil, water source, air, etc.

The utility model patent with the application number 201320168274.2, named “new device for processing chlorosilane slurry by extraction method”, discloses a new device for processing chlorosilane slurry by extraction method. The chlorosilane slurry is processed by combining extraction and distillation to obtain the final product of organic chlorosilane and oil residue. The process is safer and more environmentally friendly, and the theoretical value of the recycling rate of the chlorosilane is increased to nearly 100%. However, the disadvantages of this solution are that the selection of the extractant has strict requirements and that the design of the distillation column is not clearly described in the utility model patent. These disadvantages bring unnecessary problems in expanding industrial production and subsequent maintenance.

The utility model patent with the application number 201621122486.7, named “system for processing chlorosilane polymer by combining fixed bed reactor with distillation column”, discloses a system for processing chlorosilane polymer by combining a fixed bed reactor with a distillation column, and the system can effectively improve the recycling rate of the chlorosilane polymer. The chlorosilane polymer is processed by combining a catalytic reaction and a distillation purification to be gradually cracked into chlorosilane and then purified by the distillation, which can effectively improve the conversion rate and the recycling rate of the chlorosilane polymer and finally obtain a high value-added chlorosilane. However, the disadvantage of this solution is that the solid-liquid separation is not carried out in advance, so the feed pipeline can be blocked, which even affects the work of the distillation column, thereby increasing the difficulty of manual cleaning.

The utility model patent with the application number 201921784860.3, named “system for processing chlorosilane residue”, discloses a system for processing chlorosilane residue. The system is composed of a crude filtration device, a first distillation device, a quenching device, a fine filtration device, a pyrolysis-reaction device, and a second distillation device. The system can effectively remove metal chlorides and effectively recycle and utilize chlorosilane high boiling substances, so the recycling rate of chlorosilane residue can reach 99%. However, the disadvantages of this solution are: Although the recycling rate of the chlorosilane residues is high, the processing is more prolonged, resulting in inevitable waste and increased investment in energy consumption and costs.

Therefore, the processing of the chlorosilane slurry produced in the polysilicon production process in China has become one of the bottlenecks restricting the development of polysilicon.

### SUMMARY

The objective of the present invention is to overcome the defects of complex solid-liquid composition, low cracking degree, many by-products, and low recycling rate of chlorosilane slurry and to provide a new cracking method for a reactive distillation of chlorosilane slurry, which is simple to operate and easy to produce in the industry and can maximize the recycling of effective components in the slurry and reuse the catalyst.

To achieve the above objective, the technical solution of the present invention includes:

Feeding a chlorosilane slurry (S1) into a phase separator (V1), drying a solid phase (S2) in the phase separator, feeding a chlorosilane polymer (S3) into a plate distillation column (T1) for a cracking reaction under the action of an ionic liquid catalyst, returning kettle materials (S6, S7) of the plate distillation column (T1) through a reboiler (E2) to the plate distillation column (T1), dividing a material produced from a top of the plate distillation column (T1) through a condenser (El) into two parts, returning a part of the material (S4) to the plate distillation column (T1), and obtaining a chlorosilane product (S5) from a part of the material (S4).

### BRIEF DESCRIPTION OF THE DRAWINGS

Figure shows a schematic diagram of a cracking process for a reaction distillation of chlorosilane slurry of the present invention.

Specifically, the reference numerals in the Figure are as follows: T1. plate distillation column; V1. phase separator; V2. buffer tank; El. condenser; E2. reboiler; S1. chlorosilane slurry; S2. phase separator produced material; S3. chlorosilane polymer; S4. tower top returning material; S5. chlorosilane; S6 and S7. tower kettle returning material.

### DETAILED DESCRIPTION OF THE EMBODIMENTS

### Embodiment

Chlorosilane slurry (polysilyl chlorosilane high boiling substances with monosilyl chlorosilane and hexachlorosilane as main components, fine silica powder, and aluminum, titanium, iron, and other metal chlorides) is sent to the phase separator for a separation to achieve the solid-liquid separation. Insoluble solids such as silica powder in the chlorosilane slurry can be filtered out and dried. The filtrate containing the chlorosilane polymer is sent to the plate distillation column for cracking distillation to achieve the cracking reaction of the chlorosilane polymer under the action of an ionic liquid catalyst. The light components of the chlorosilane polymer undergo the steps of distillation, condensation, and extraction to obtain the chlorosilane product with a high recycling rate.

What is claimed is:

1. A cracking process method for a reaction distillation of a chlorosilane slurry, comprising: feeding the chlorosilane slurry into a phase separator, drying a solid phase in the phase separator, feeding a chlorosilane polymer into a plate distillation column for a cracking reaction under an action of an ionic liquid catalyst, returning kettle materials of the plate distillation column through a reboiler to the plate distillation column, dividing a material produced from a top of the plate distillation column through a condenser into two parts, returning a first part of the material to the plate distillation column, and obtaining a chlorosilane product from a second part of the material.

2. The cracking process method according to claim 1, wherein the cracking process method comprises a solid-liquid separation step and a reaction distillation step.
